(19) United States
(12) Patent Application Publication
(10) Pub. No.: US 2011/0199490 A1
(43) Pub. Date: Aug. 18, 2011

(54) HANDHELD PORTABLE FIBER OPTIC SERVICE DIAGNOSTIC TOOL AND METHODS FOR SAME

(75) Inventors: Steven K. Shafer, Chittenango, NY (US); Raymond Palinkas, Canastota, NY (US); Erdogan Alkan, Fayetteville, NY (US)

(73) Assignee: John Mezzalingua Associates, Inc., East Syracuse, NY (US)

(21) Appl. No.: 12/708,149

(22) Filed: Feb. 18, 2010

(51) Int. Cl. H04N 17/00

(52) U.S. Cl. 348/184; 348/E17.003

(57) ABSTRACT

Embodiments according to the present application can provide hand held portable diagnostic tools and methods for using the same that can terminate a user port in a coaxial cable system to detect whether a digital service marker indicating that fiber optic digital CATV service is present. Embodiments of a hand held portable tool and methods for using the same can include a connector attached at one end of a housing to pass a downstream signal from a coupled user-side coaxial cable port, and a power detector. The detector includes a first filter to pass a selected bandwidth and a rectifying power detector circuit to detect RF power in the selected bandwidth indicative of the digital service marker. Upon detection of the digital service marker, an indicator in the hand held portable diagnostic tools provides detectable or visual results to the user.

### FIELD OF THE INVENTION

The present invention relates generally to bi-directional community antenna television (“CATV”) networks, and more specifically, to portable handheld diagnostic systems and methods for detecting digital service markers at user ports of a drop system of a CATV network.

### BACKGROUND OF THE INVENTION

A typical CATV network provides many content selections to a customer's media device by way of a single electrically conductive cable that provides a signal stream to the media device. A typical CATV or cable television network includes a head end facility from which a plurality of feeder cable lines emanate. The feeder cable lines branch off at a tap having ports. A drop cable, which may be a single coaxial cable, extends from each port of the tap to a respective user or customer premise. The CATV system is a two-way communication system. A downstream bandwidth carries signals from the head end facility to a user and an upstream bandwidth carries upstream signals from the user to the head end facility.

The system operator can be a service provider capable of providing unidirectional or bidirectional services such as cable TV services, Internet services, and/or telephone services individually or bundled in various combinations. For example, an exemplary bundled package includes phone, television, and Internet service. When bundled services are ordered through a telephone company, the bundle can have satellite TV, landline phone, DSL Internet, and possibly cellular service. When bundled services are ordered through a cable company, the bundle can have cable TV, cable Internet, and digital phone service. Although generally, service providers can provide bundled services, individual services can also be purchased by the user (e.g., for use in the home).

For example, individual home phone service can be installed or purchased for landline, Internet, or digital phone service for each user or customer premise. Traditional landline phone service includes local and long distance service with unlimited or cent per minute billing Internet phone service or VOIP includes unlimited local and long distance over Internet phone service for domestic and international VOIP phone calls using the home phone and a VOIP router. Similarly, various types of Internet and cable TV service can be purchased individually.

Thus, downstream bandwidth of the CATV system may include but is not limited to broadcast television channels, video on demand services, Internet data, home security services, and Voice-Over-Internet (VOIP) services. Upstream bandwidth may include but is not limited to data related to video on demand, Internet access, security monitoring, or other services provided by the system operator. In one possible configuration, the upstream and downstream bandwidths are transmitted between the head end facility and the tap via optical fiber, and between the tap and the user or customer premise via coaxial cable. In another configuration, fiber optic drop lines are converted to coaxial cable before or after entering a user's dwelling. Alternatively, the upstream and downstream bandwidths are transmitted from the head end facility to the plurality of users using coaxial cable. Upstream and downstream bandwidths are typically transmitted via oscillatory electrical signals propagated along the cable lines in a discrete frequency range, or channel, that is distinct from the frequency ranges of other content selections. Downstream bandwidth frequencies typically range from 50-1,000 megahertz (MHz), and upstream bandwidth frequencies typically range from 7-49 MHz.

Each drop cable (e.g., coaxial cable) entering a user's dwelling usually enters a splitter having multiple outlet ports. Distribution cables connected to the outlet ports of the splitter route the signals to various rooms, often terminating at a wall jack. In many installations, the distribution cable is split again, depending on component setup. The network of distribution cables, splitters, and distribution points is referred to as a drop system. Within the drop system, not every port on a splitter may be utilized, and not every wall jack within a structure may have a service provided to it or be connected to the current purchased services. Some wall jacks are not even physically connected to the drop system, but are configured as cosmetic placeholders.

One difficulty with the drop system is the installed configuration of the drop system can change over time. New houses can be prewired during construction to implement a single video distribution panel for a CATV/video drop system having wall jacks in each room. This exemplary method of wiring using a single video distribution panel and direct cable lines therefrom is known as the “star” configuration. The star configuration helps in the isolation of wiring problems. Signal splitters and signal splitter/combiners are added for proper routing of the video signal to each location. The video distribution panel can compensate a calculated dB loss for each run using video signal amplifiers. A “run” in the drop system can exist between the video distribution panel and the terminating wall jack or customer component/video equipment. The video signal strength should be equalized throughout the entire coaxial cable runs. CATV/video distribution panels can be purchased off-the-shelf or custom built for most drop system installations.

For in-house drop systems (e.g., wirings) installed (e.g., by cable TV companies) on existing homes, splitters are usually randomly installed at the cable TV entrance point and some other convenient splitting points. This configuration can form a “star daisy chain” topology similar to that of in-house telephone wiring except a splitter is used at every cable branch point. For example, basements or attics can provide for the wiring of one floor or a cluster of rooms of the home. Alternatively, in-house wiring for CATV drop systems in existing homes can be installed only to the one or two rooms that have the user or customer premise device such as TVs to be connected to the purchased service.

Satellite CATV system installations can fall into any of the above situations.

Another difficulty with the drop system is the large number of splitters and wall jacks are generally undocumented and a portion or all of the drop system is hidden out of sight behind walls. Thus, the physical configuration of the drop system can be unknown by the user or a service provider.

Another problem with the large number of splitters and wall jacks in the drop system is that multiple service operators can independently and concurrently provide different services to subsets of the wall jacks (or subsets of the drop system). Further, the user can instantly change a type of service and/or a service provider for each of at least telephone, data or Internet service, and CATV services. Users can lose track of which service provider is currently contracted to provide services or the type of or extend of contracted services provided.

Additional difficulties in the drop system can be caused by the various differing procedures by which service operators terminate service to a customer. For example, service providers can remove equipment outside or inside the customer premise between the head end facility and the drop system. Alternatively, service providers can terminate a service contract by disconnecting the upstream and downstream bandwidth (e.g., services provided to the drop system) while installed equipment is left outside and/or inside the home of each user. Additional complexities can occur in multi-unit dwellings.

### SUMMARY OF THE INVENTION

In one aspect according to the application, methods and apparatus for a portable handheld diagnostic tool can discriminate a digital service provided to user ports in a drop system.

In one aspect according to the application, methods and apparatus for a portable handheld diagnostic tool can identify a fiber optic service marker provided to user port in a drop system.

In one aspect according to the application, a portable hand held diagnostic tool can detect a digital service marker provided to discriminate types of CATV service currently provided for viewing equipment coupled to a drop system.

### BRIEF DESCRIPTION OF THE DRAWINGS

Novel features that are characteristic of embodiments of the invention are set forth with particularity in the claims. The invention itself can be understood, with respect to its organization and method of operation, with reference to the following description taken in connection with the accompanying drawings in which:

FIG. 1A shows a simplified schematic view of a CATV network showing an exemplary drop system according to one embodiment of the invention;

FIG. 1B shows a simplified schematic view of a CATV network showing an exemplary drop system according to one embodiment of the invention;

FIG. 2 shows a schematic diagram of an exemplary handheld portable digital marker detection tool according to one embodiment of the invention;

FIG. 3 shows a circuit diagram for an embodiment of a detector for a hand held portable digital marker detection tool;

FIG. 4 shows a diagram illustrating an exemplary downstream analog channel and an exemplary downstream digital channel;

FIG. 5 shows a perspective view of an exemplary handheld portable digital marker detection tool according to one embodiment of the invention; and

FIG. 6 is a flow chart that illustrates an embodiment of a method according to one embodiment of the invention.

### DETAILED DESCRIPTION OF THE EXEMPLARY EMBODIMENTS

The use of a CATV system to provide Internet, Voice-Over-Internet protocol (“VOIP”) telephone, television, and music services is well known in the art. In providing these services, a downstream bandwidth (e.g., radio frequency (“RF”) signals, digital signals and/or optical signals) is passed from a supplier of the services to a user and an upstream bandwidth (e.g., radio frequency (“RF”) signals, digital signals, and/or optical signals) is passed from the user to the supplier. For much of the distance between the supplier and the user, the downstream and the upstream bandwidth make up a total bandwidth that is passed via a single transmission line, such as a fiber optic cable or a coaxial cable. The downstream bandwidth is, for example, signals that are relatively higher frequencies from within a total bandwidth of the CATV system while the upstream bandwidth is, for example, signals that are relatively lower frequencies.

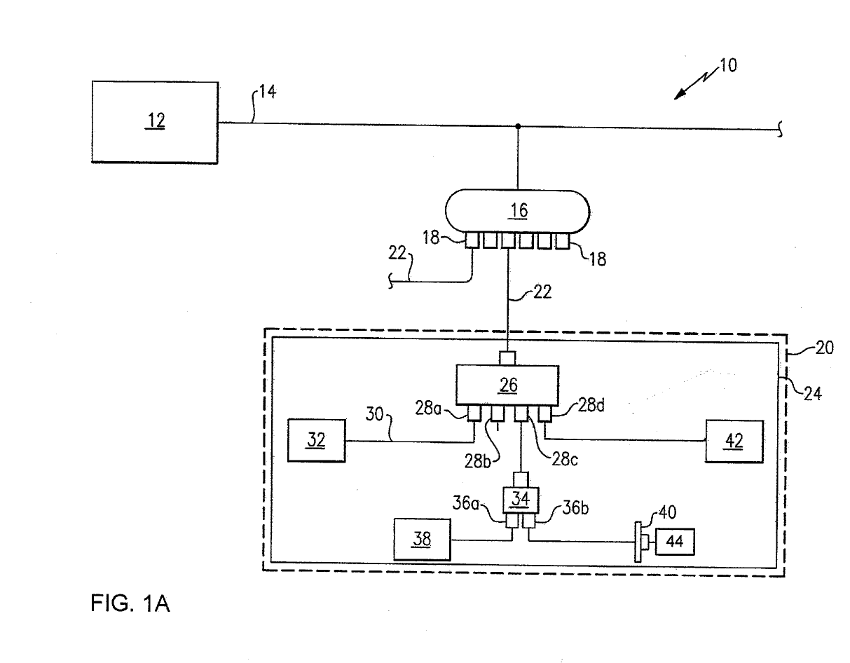

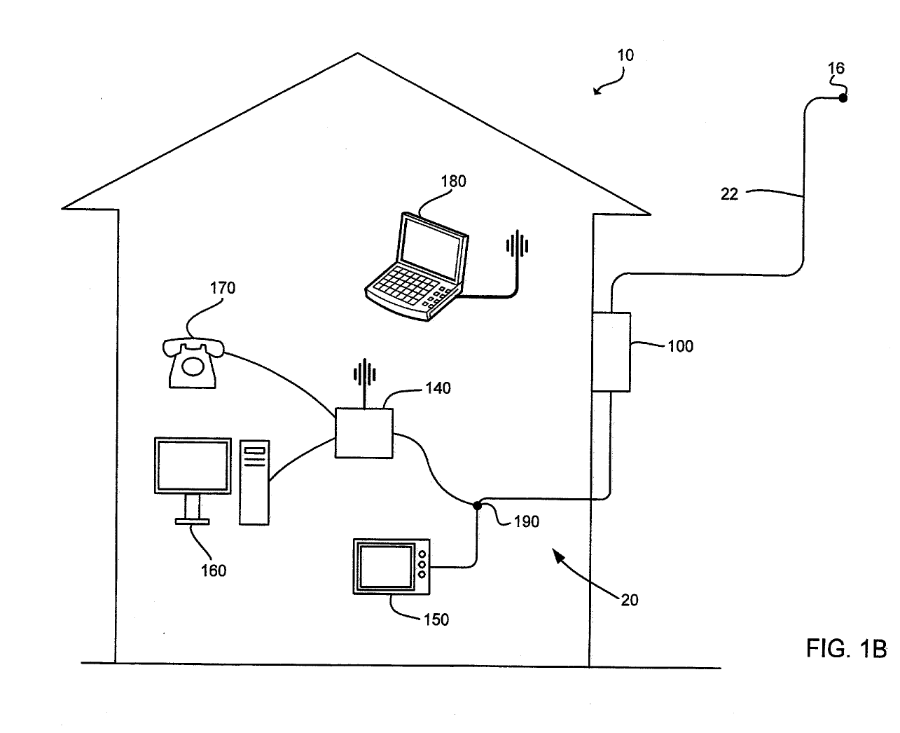

Referring to the simple schematic of FIG. 1A, a portion of a CATV or cable television network 10 includes a head end facility 12 for processing and distributing signals over the network. Typically the head end facility 12 is controlled by a system operator and includes electronic equipment to receive and re-transmit video and other signals over the local cable infrastructure. One or more main distribution lines 14 carry the downstream bandwidth from the head end facility 12 to a tap 16 configured to serve a local distribution network of about 100 to 500 end users, customers, or subscribers. The tap 16 includes a plurality of tap ports 18 that are configured to carry the downstream bandwidth to a user's drop system 20 via a drop cable 22, which may be a single coaxial cable.

The drop cable 22 typically enters a user's dwelling 24 and connects to one or more splitters such as a first splitter 26. In one embodiment, the first splitter can be a video distribution panel. In FIG. 1A, the first splitter 26 is a four-way splitter having four distribution ports 28a-28d. A coaxial cable 30 connects port 28a to a first user device 32, which may be set top box, for example. Port 28b is shown as an open port; meaning there is no device connected to it. Port 28c is shown connected via coaxial cable to a second splitter 34. The second signal splitter 34 is illustrated as a two-way splitter having two distribution ports 36a and 36b. Port 36a is connected to a second user device 38, which may be a cable modem. Port 36b is connected via coaxial cable to a wall jack 40. In the illustrated example, the wall jack 40 is directly connected to a fourth user device 44, which can be a television (e.g., without an STB). Port 28d is connected via coaxial cable to a third user device 42, which may be a digital telephone supporting Voice-Over-Internet protocol.

The drop system 20 can be difficult to access and control by the cable service providers. In the disclosed embodiment, the drop system 20 is in the user's dwelling 24. However, it should be understood that the drop system 20 can be placed at any location such as a home, a premise, an apartment building, a public facility, a business, or the like where CATV services, including but not limited to Internet services, VOIP services, or other unidirectional/bidirectional services, are being used.

As shown in FIG. 1B, examples of services passed through the user's premise drop system 20 can include but is not limited to telephone, data or Internet service, and CATV services. Thus, the user's premise drop system 20 may be split using a splitter 190 so that downstream/upstream bandwidth can pass to/from a television 150 and a modem 140. The modem 140 may include VOIP capabilities affording telephone 170 services and may include a router affording Internet services to a desktop computer 160 and a laptop computer 180, for example.

Additionally, it is common practice to provide a set-top box (“STB”) or a set-top unit (“STU”) for use directly with the television 150. For the sake of clarity, however, there is no representation of a STB or a STU included in FIG. 1B. The STB and STU are mentioned here in light of the fact that many models utilize the upstream bandwidth to transmit information relating to “pay-per-view” purchases, billing, utilization, and other user interactions, all of which may require information to be sent from the STB or STU to the head end facility 12. Accordingly, it should be understood that each exemplary device (e.g., a modem, a STB, a STU, and/or a dedicated VOIP server) can transmit desirable upstream information signals via the upstream bandwidth in the drop system 20.

In contrast to service providers such as cable companies that require the installation of the equipment at the customer's home be done by a qualified technician, other service providers use a customer installation approach. In one exemplary customer installation approach, the customer gets the equipment from a retailer or outlet store, takes the equipment home, and then the customer installs the equipment. Alternatively, in the customer installation approach, the equipment can be remotely purchased and shipped to the customer for the customer to subsequently install upon arrival.

Installation of CATV service provider equipment by the customer can require the identification of services distributed through the drop system at the customer premise to reduce or prevent customer complaints and costly technician service calls related to installation.

One aspect of the customer installation approach is addressing errors occurring during start-up of the service. Such errors can include improper installation by the customer. Many errors are caused by the customer such as improper connection or installation of the equipment. However, some errors can be caused by the service provider such as faulty equipment or lack of service. Upon initiation of the service, improper connection of the equipment or equipment failure can both result in an identical error condition—lack of service to the customer provided at the newly installed equipment.

One common difficulty in using the customer installation approach is not being able to detect whether the service being supplied to the home of the customer is from a fiber optic service provider or a coaxial cable service provider. Installation by the customer of equipment from a service provider delivering digital services over fiber optic cable will not operate if connected to a user-side port without service or with analog service and/or mixed analog/digital CATV service.

In one embodiment, a portable hand held diagnostic tool and methods therefore can discriminate a service supplied to the user's dwelling. In one embodiment, a portable hand held diagnostic tool can identify a fiber optic service provider marker provided at the drop system 20.

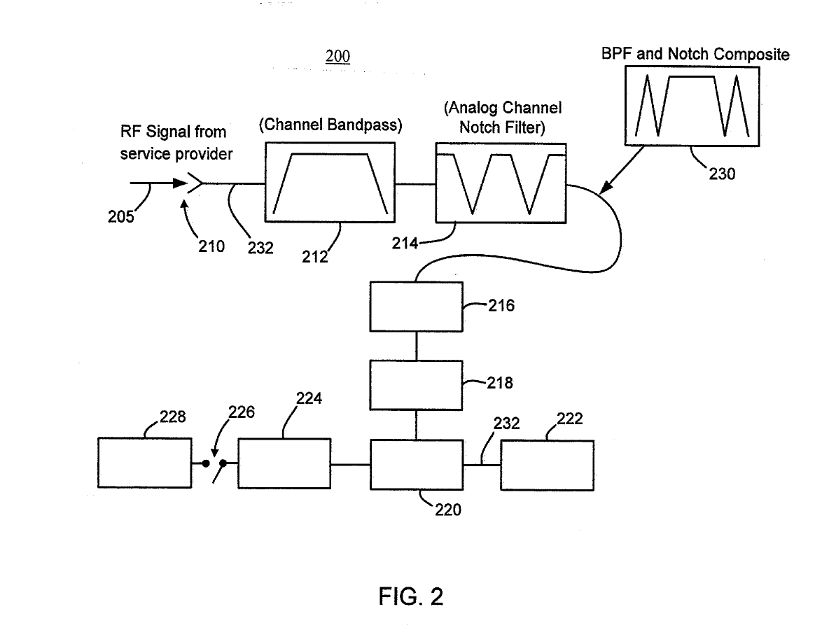

FIG. 2 is a diagram that illustrates an embodiment of a handheld portable fiber optic digital marker diagnostic tool. As shown in FIG. 2, a portable handheld fiber optic digital service marker diagnostic tool 200 can include a connector 210, band pass filter 212, an analog notch filter 214, a detector circuit 216, a calibration circuit 218, a display driver 220, a first display 222, a power supply 224, an on/off switch 226 and a second display 228. The portable handheld fiber optic digital service marker diagnostic tool 200 can terminate a downstream bandwidth received from the supplier.

In one embodiment, the connector 210 is exposed in a housing of the portable handheld fiber optic digital service marker diagnostic tool 200. The connector 210 can extend through the housing or be outside but electrically coupled to a signal path 232 between the connector 210 and the first display 222. In the exemplary embodiment, the connector 210 is a male cable connector, but one of ordinary skill in the art can readily construct a connector having alternate configurations for electrically coupling to a user port (e.g., 28a-28d, 36a, 36b, 40).

When connected to a user-side port 205, the connector 210 can pass a downstream signal to the series connected band pass filter 212 and the analog notch filter 214. The band pass filter 212 is fixed and can selectively pass a single bandwidth or such as a channel or channels of the downstream signal containing the fiber optic service marker from the service provider. For example, the fiber optic service marker can be provided by the head end facility 12. For example, a channel passed by the band pass filter 212 can be a six megahertz bandwidth between 76-82 megahertz. The passed channel is then applied to the analog notch filter 214 that removes or blocks signals corresponding to an analog signal (e.g., to the video and audio signals in an analog channel). For example, the analog notch filter 214 can include a first notch and a second notch as shown in FIG. 2. The first notch is to remove the video signal and the second notch is approximately 4.5 megahertz higher in the passed bandwidth to remove the audio signal in the analog channel. However, embodiments of the application are not intended to be so limited. For example, a portion such as half a channel can be passed by the band pass filter 212 that may result in a single notch filter in the analog notch filter 214. In one embodiment, the analog notch filter comprises the capability to attenuate at least one fixed frequency or selected frequency or a selected frequency band.

An exemplary idealized representation of the signal exiting the analog notch filter 214 is shown in FIG. 2 as signal 230.

The detector circuit 216 is connected to receive an output signal of the analog notch filter 214. The detector circuit 216 can determine characteristics of the output signal received from the analog notch filter 214. In one embodiment, the detector circuit 216 can be implemented to be able to measure the power content or power level in the downstream bandwidth radio frequency signal of the signal 230. For example, the detector circuit 216 can be configured as a rectifier, such as a log detector or peak detector, to rectify the radio frequency signal to be able to measure the power contained therein.

The calibration circuit 218 is connected to receive an output signal of the detector circuit 216. The calibration circuit 218 can process the output signal of the detector circuit 216 to determine when the fiber optic digital service marker is included in the signal 230 (e.g., at the user-side port 205). In one embodiment, the calibration circuit 218 compares the output signal of the detector circuit 216 to a reference signal. When the output signal of the detector signal is greater than the reference signal, the fiber optic digital service marker was present in the signal 230. Otherwise, the fiber optic digital service marker was not present in the signal 230. For example, the calibration circuit 218 can output a high signal level or logic level “1” to indicate the presence of the fiber optic digital service marker in the signal 230 and a low signal level or logic level “0” otherwise.

The display driver 220 is connected to receive the output signal of the calibration circuit 218. When the high level signal is received from the calibration circuit 218, the display driver 220 can operate to illuminate the words digital service “detected” on an LCD being the first display 222. In one embodiment, the first display 222 can be an LED, when the high level signal is received because the fiber optic digital (e.g., LED) service marker is present, the display driver 220 can connect the first display 222 (e.g., LED) to the power supply 224 by controlling switch 226. However other implementations of the first display such as a meter, display device, an image sensor, or the like are also contemplated. In one embodiment, the power supply 224 is a battery that can be mounted within the housing of the portable handheld fiber optic digital service marker diagnostic tool 200.

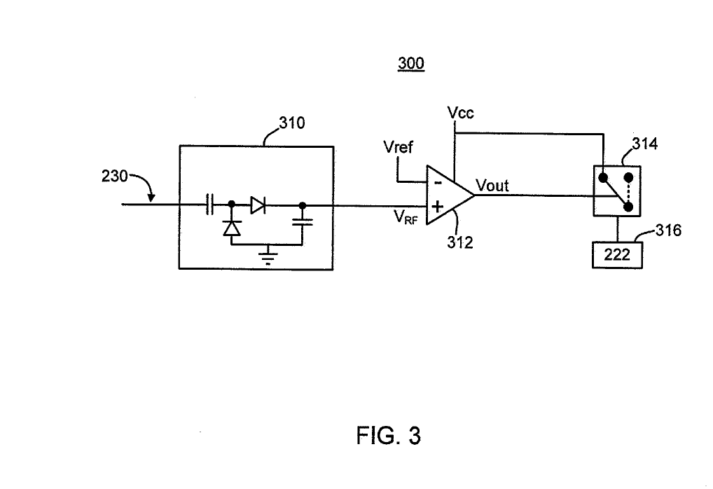

FIG. 3 is a diagram that illustrates an exemplary embodiment of a detector that can be used in the portable handheld fiber optic digital service marker diagnostic tool 200. As shown in FIG. 3, a detector 300 can be implemented in one embodiment as the detector circuit 216, the calibration circuit 218, the display driver 220, and the first display 222 in FIG. 2. In one embodiment, the detector circuit 300 can include a rectifier 310, a comparator element 312, a switch 314, and a LED 316.

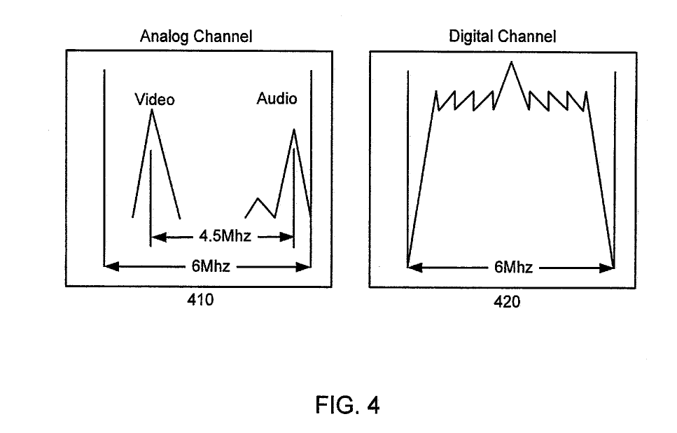

As shown in FIG. 3, the incident signal 230 may be input to a rectifier 310, such as a log detector or peak detector, to rectify the radio frequency signal to be able to measure the power content. The output of the rectifier 310 is a DC voltage V_{RF} representative of the power level in the incident signal 230. When the fiber optic digital service marker is present, the incident signal 230 contains radio frequency signal having a significant, non-zero and detectable power level that results the output signal or the voltage V_{RF} from the rectifier 310 being a detectable non-zero voltage. In one embodiment, the fiber optic digital service marker is a digital marker in the selected channel For example, the fiber optic digital service marker can be a digital channel transmitted in a selected channel (e.g., channel 5) such as 76-82 megahertz. Although not shown, the signal may further be conditioned through an amplifier and/or analog-to-digital converter. An exemplary analog cable channel 410 and an exemplary digital cable channel 420 are shown in FIG. 4.

In the disclosed embodiment, the voltage value V_{RF} and a reference voltage value V_{ref} are input to a comparator element 312. The comparator element 312 can compare the reference voltage value V_{ref} to the incident voltage value V_{RF} (e.g., the incident signal 230) and determine the presence of the fiber optic service marker. The reference voltage value V_{ref} can be a fixed reference voltage equal to ground voltage (e.g., zero volts), a small non-zero voltage level, or a value representative of noise in the downstream signal or the user-side port 205. For example, the level of noise in user-side port 205 can be −30 dB.

In the disclosed example, if no fiber optic service indicator is contained in the downstream signal connected to the user-side port 205, the voltage value V_{RF} in the incident signal 230 will be insignificant, or zero and the output of the comparator element 312 will also be zero voltage level or a low level. There being no signal from the comparator element 312, a switch 314 operating as the display driver 220 remains in the open state, which does not connect a LED 316 to the power supply 224. In the event the fiber optic service marker is contained in the downstream signal connected to the user-side port 205, the non-zero voltage value V_{RF} in the output signal of the rectifier 310 can cause the output of the comparator element 312 to change from a zero to a high voltage level one (or high level) and an output voltage signal (Vₒᵤₜ) enables the switch 314 to move to the closed state, thereby allowing the power supply 224 to be connected to the LED 316 to enable the LED 316 and provide feedback to a user that the user-side port 205 is connected to a digital downstream bandwidth provided by a fiber optic service provider.

Other detector circuits are contemplated, so long as the input power in the fiber optic service indicator can be determined and used to provide an indication (or lack thereof) to the user.

In another embodiment, the signal passing from the rectifier 310 can be input to a microcontroller (not shown) in the portable handheld fiber optic digital service marker diagnostic tool 200. The microcontroller may be programmed to relay a control signal to the switch 314 responsive to the output of the comparator element 312. In the disclosed example, if there is no fiber optic service marker provided to downstream bandwidth in the user-side port 205, the incident voltage value V_{RF} can be zero. In that event, the microcontroller may be programmed to command the switch 314 to the open state. When the fiber optic service marker is provided to the user-side port 205, the incident voltage value V_{RF} will be a non-zero value, and the microcontroller can be programmed to command the switch 314 to the closed state, allowing the LED 316 to illuminate.

Alternatively, the output (Vₒᵤₜ) of the comparator element 312 can be directly connected the LED 316. For example, the LED 316 can be connected between the power supply 224 at a first terminal for illuminating the LED 316 and the output of the comparator element 312 at a second terminal. In this example, when the fiber optic service marker is present in the incident signal 230, the comparator element 312 can output a low signal that can create a voltage difference between first and second terminals of the LED 316 to turn on the LED 316. When the fiber optic service marker is not present in the incident signal 230, the comparator element 312 can output a high signal so that there is an insufficient voltage difference to illuminate the LED 316.

In one embodiment, a drop system includes an exemplary signal path extending from a supplier-side through an output of a user-side port 205. Referring back to FIG. 1A, in one example the user-side port 205 may be any of the illustrated distribution ports 28a-28d, 36a, 36b, or the wall jack 40. The exemplary signal path includes a conductor, such as the center conductor in a coaxial cable, to carry the upstream and downstream bandwidth. The exemplary signal path further includes a ground, such as the outer sheath of a coaxial cable that provides a path to ground with various cable connector devices.

Returning to FIG. 2, the display driver 220 can include an electrically-controlled switch 314 disposed in the signal path 232. In the illustrated example, the switch 314 is a single pole, single throw switch. The switch 314 is configured with at least a first state and a second state. In the illustrated example, the first state is an open state and the second state is a closed state. In the open state, which will be utilized when there is no fiber optic service marker present, the switch 314 disrupts and does not connect a supply voltage level to the first display 222 (e.g., LED). In the disclosed embodiment, the closed state of the switch 314, which will be utilized when there is a fiber optic signal present at the user-side port 205, can connect the supply voltage level (e.g., battery 224) to provide power to the first display 222. Preferably, the first display 222 can be the indicator exposed in the surface of the housing of the portable handheld fiber optic digital service marker diagnostic tool 200.

The portable handheld fiber optic digital service marker diagnostic tool 200 can be a passive detector to passively evaluate the downstream bandwidth. As used herein, “passively evaluate” is defined as using existing signals in the communication path as opposed to injecting an electrical signal to a communication port. In the disclosed embodiment, the passive detector can include a fixed pass filter as the filter 212, the analog notch filter 214, the detector circuit 216, and the calibration circuit 218. The downstream bandwidth is received through the connector 210.

In one embodiment, the output of the rectifier 310 can be passed through an analog-to-digital converter, the digital output of which is utilized by a microcontroller in determining whether the switch 314 should be open or closed. In one illustrative example, the range of values corresponding to the voltage V_{RF} can be stored in a lookup table in the memory of the microcontroller, as well as a set of corresponding instructions for each value. In the example, an actual V_{RF} value, as output from the analog-to-digital converter, having a value less than a prescribed value such as 0.3 (e.g., a low or zero logic level) will result in the switch 314 remaining open, while actual V_{RF} values greater than 0.3 (e.g., a high or one logic level) indicate the fiber optic service marker and a command will be sent to close the switch 314.

The circuit of the present invention may be designed to connect (e.g., via the connector 210) to a coaxial cable connector, such as a tap, splitter, wall plate, or the like. The exemplary connector 210 can be formed from C36000 brass, (ASTM B16, ½ hard), but other materials may be used. Although the exemplary connector 210 has an exterior surface having a conical shape, a variety of exterior surface shapes may be used. For example, the connector 210 may be cylindrical, hexagonal, have at least two opposing flat surfaces or may have two or more sections, each having a different shape (e.g., a cylindrical section and a conical section). Other shapes are also contemplated.

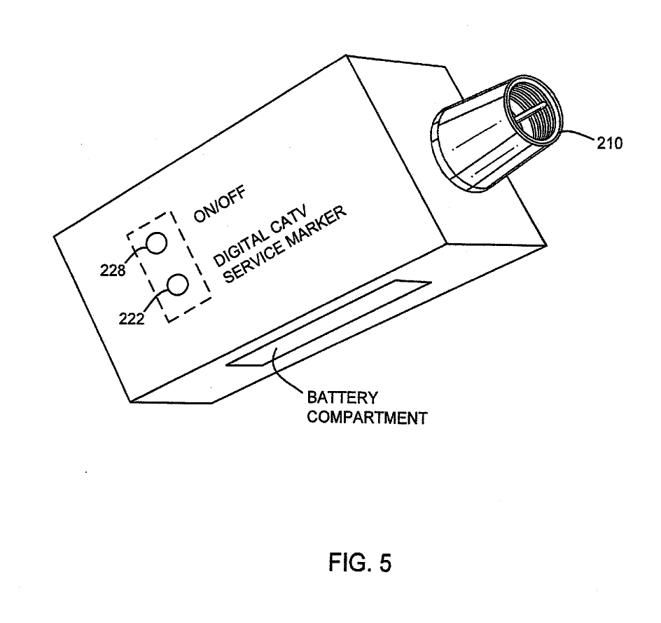

The housing can be formed of a hard impact-resistant material, plastic or polymer, or a hard electrically insulating material. A perspective view of an exemplary portable handheld fiber optic digital service marker diagnostic tool is shown in FIG. 5.

The circuits 200, 300 disclosed herein are not limited to the components shown. Electrical equivalents of the circuits 200, 300 may be utilized and other types and combinations of components that provide the desired functionality may be used consistent with the invention. It will also be appreciated that the circuits 200, 300 may be rendered in literally any physical form, including without limitation: (i) as a circuit composed of discrete circuit elements (i.e., resistors, capacitors and diodes); or (ii) as an integrated circuit, either in a stand-alone form or integrated with a parent device, such as with a splitter or tap device.

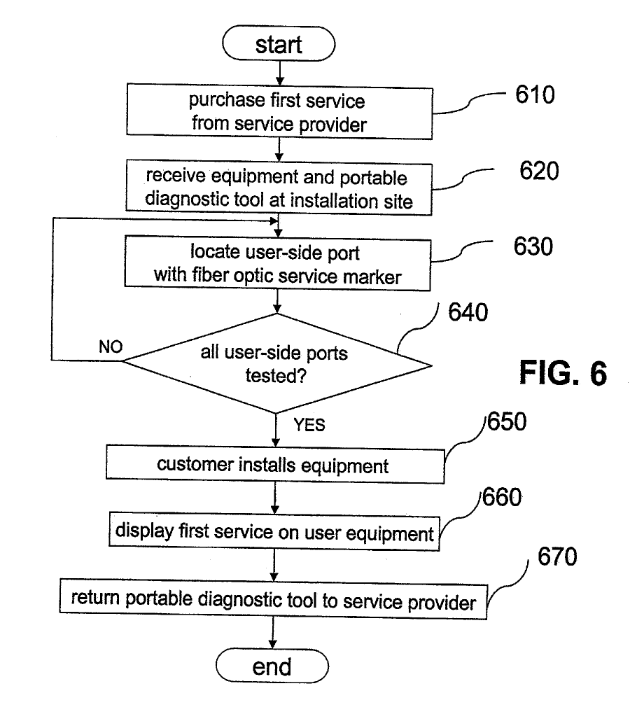

An embodiment of a method of receiving CATV services through a user-side port to (customer) installed equipment in a drop system of a CATV system according to the application will now be described. The method embodiment shown in FIG. 6, can be implemented with and will be described using a portable handheld fiber optic digital service marker diagnostic tool and CATV system embodiment shown in FIGS. 2-3, however, the method embodiment is not intended to be limited thereby.

As shown in FIG. 6, after a process starts, a CATV first service to be provided using a CATV system from a service provider (e.g., on-demand movie service) is contracted for or purchased by a customer (operation block 610). The first service can be a new bundled service, a new independent service, or a modification to existing service from a selected service provider. In one embodiment, the first service can be purchased via a service provider representative in a retail establishment (e.g., store or mall kiosk) or via the telephone or Internet. Upon purchasing the first service, the customer is provided (e.g., rented) equipment (e.g., STB) to connect between a user-side port in the drop system and a user owned viewable display (e.g., TV) in the customer's home where the first service is to be displayed. Alternatively, STB equipment for providing the first service can be shipped to the customer's premise. Further, the customer is provided a portable handheld fiber optic digital marker diagnostic tool with the STB equipment to allow the customer to accurately, properly, and completely install the STB equipment (operation block 620).

At this point, the service provider can provide (e.g., enable) the first service using a downstream bandwidth transmitted by the service provider to the customer drop system. In one embodiment, the service provider can remotely control the supply of the downstream bandwidth to the customer premise using previously installed drop line and head end equipment. The service provider can further transmit a fiber optic digital service marker in the downstream bandwidth including the first service. Alternatively, the service provider can install necessary equipment outside the customer's premise, if needed, to provide the first service to the customer drop system.

Using the portable handheld fiber optic digital marker diagnostic tool (e.g., tool 200), the customer can determine which, if any, of the user-side ports in the drop system at the customer's premise are connected to the first service (operation block 630). The customer can individually test each user-side port in a physical location (e.g., room) until all user-side port(s) at that location have been tested (operation block 640). Usually, a subset of user-side ports or at least one user-side port in the drop system is connected (e.g., to the drop line) to receive the first service from the service provider. In one embodiment, an indicator of the portable handheld digital marker diagnostic tool will be illuminated when the portable handheld digital marker diagnostic tool is temporarily connected to each of the subset of user-side ports in the customer drop system that provide the digital service marker.

If no user-side ports receive the first service (e.g., are connected to the drop line of the service provider) the customer can contact the service provider to fix the installation site or cancel the first service. Alternatively, if the first service is not provided to a specific user-side port desired by the customer, the customer drop system can be reconfigured and retested (operation blocks 630-640).

Next, the customer can install the equipment (e.g., STB) between a user-side port passing the first service and a selected user device (e.g., TV). For example, in such a manner, CATV service could be added to additional TVs in a customer premise (operation block 650). Then, the first service can be displayed at the user device (operation block 660). In one embodiment, the customer then returns the portable handheld fiber optic digital marker diagnostic tool to the service representative of the service provider or to the service provider (operation block 670). In another embodiment, the portable handheld fiber optic digital service marker diagnostic tool is then discarded. From operation block 670, the process can end.

One advantage of exemplary embodiments of portable handheld fiber optic digital marker diagnostic tools, systems and methods for the same disclosed herein is that, when connected to a user-side port in a drop system of a premise in a network 10, the embodiments can indicate the presence of a fiber optic digital service marker to the user or customer.

Embodiments of a diagnostic tool and methods for using the same according to the application disclosed a band pass filter to pass a fixed bandwidth. However, embodiments according to the application are not intended to be so limited. For example, a tunable pass filter could be implemented (e.g., varactors) to pass a selected bandwidth. Further, although responsible for additional insertions losses, alternative embodiments of the diagnostic tool can use a single band pass filter (e.g., a SAW filter) to pass a central portion of a representative downstream signal (e.g., between the notches) as an incident signal to a power detector.

Embodiments of a diagnostic tool and methods for using the same according to the application disclosed a single use diagnostic tool. However, embodiments according to the application are not intended to be so limited. For example, a customer could continuously use an installed diagnostic tool at a user port to provide an indication of services provided by the supplier to a downstream bandwidth at a selected user port. In such an embodiment, an additional connector can be implemented to couple the diagnostic tool between a set top box (e.g., a controller or supplier equipment) and customer equipment including a viewable display.

The description herein may use the terminologies signal(s) and signal line(s) interchangeable with respect to the figures. That is, the terminology signal may correspond to a signal line as shown in the figures. Arrangements and embodiments may also be described with respect to signals being input or output from different circuit components. While the discussion identifies a signal, the signal may be transmitted over a signal line or other type of mechanism. Further, while values or signals may be described as HIGH or LOW and/or UP or DOWN, these descriptions are intended to be relative to the discussed arrangement and/or embodiment. For example, a value or signal may be described as HIGH in one arrangement although it may be LOW if provided in another arrangement, such as with a change in logic. The terms HIGH and LOW may be used in an intended generic sense. Embodiments and arrangements may be implemented with a total/partial reversal of the HIGH and LOW signals by a change in logic.

This written description uses examples to disclose exemplary embodiments of the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been set forth, it will be understood that features and aspects that have been described with reference to each particular embodiment can be used with each remaining particularly set forth embodiment. For example, aspects or features described with respect to embodiments directed to FIG. 6 can be used with embodiments directed to FIG. 3.

We claim:

1. A hand held portable tool to detect digital service at a user port in a coaxial cable system, comprising:
a housing;
a connector attached at one portion of the housing for connection to a user-side coaxial cable port;
a detector to detect a digital service marker provided in a downstream bandwidth at the connector, the detector coupled to the connector;
an indicator exposed in the housing to indicate presence of the digital service marker, the indicator coupled to the detector, wherein the detector comprises,
a first filter to pass a selected channel, and
a power detector circuit to detect RF power in the selected channel from the digital service marker in the selected channel.

2. The hand held portable tool of claim 1, wherein the detector comprises,
the first filter to pass a fixed bandwidth including the selected channel;
a second dual notch filter to alternate two separate frequencies in the fixed bandwidth;
a power detector unit to detect the RF power in the fixed bandwidth from the digital service marker in the selected channel;
a calibration circuit to compare the detected RF power from the digital service marker in the selected channel; and
a display driver to drive the indicator in the housing responsive to the detector.

3. The hand held portable tool of claim 2 the display driver to enable the indicator when the digital service marker is detected.

4. The hand held portable tool of claim 3 where the indicator is a light or LED, a display, an LCD, a screen, or a meter.

5. The hand held portable tool of claim 1 comprising a battery to provide a power supply to the hand held portable tool.

6. A method for detecting digital service marker at a user port in a coaxial cable system, the method comprising:
enabling a portable hand held diagnostic tool;
coupling a connector exposed in a housing of the portable hand held diagnostic tool to a user port in a premise to be tested, the coupled connector comprising a signal path extending from a supplier side port to the user port, the user port carrying a bandwidth, the signal path comprising a conductor and a ground;
passively selecting a first bandwidth from a downstream bandwidth of the bandwidth;
passively filtering the first bandwidth around two separate frequencies corresponding to analog channel signals in the selected first bandwidth;
detecting a digital service marker in the filtered first bandwidth by detecting a RF power in the filtered first bandwidth; and
setting an indicator exposed in the housing of the portable hand held diagnostic tool to a first state when the detected the RF power in the filtered first is greater than a threshold level to indicate the digital service marker is contained in the downstream bandwidth at the user port.

7. The method of claim 6, wherein the detecting the digital service marker comprises:
rectifying the filtered first bandwidth to generate a corresponding DC voltage level; and
comparing the corresponding DC voltage level to a reference level; and
outputting a high signal level as a result of the comparing when the corresponding DC voltage level is greater than the reference level.

8. The method of claim 7, wherein the setting the indicator to the first state comprises positioning a switch to connect a power supply voltage to cause an LED to illuminate.

9. The method of claim 7, wherein the reference level is zero or a corresponding noise level in the user port.

10. The method of claim 7, outputting a low signal level as the result of the comparing when the corresponding DC voltage level is less than the reference level.

11. The method of claim 6, wherein the first bandwidth is a fixed bandwidth or a fixed channel bandwidth.

12. The method of claim 6, wherein the first bandwidth is six megahertz wide and comprises a prescribed frequency CATV channel.

13. The method of claim 6, wherein the analog channel signals correspond to video and audio portions of a CATV channel.

14. The method of claim 9, wherein the two separate frequencies are approximately 4.5 megahertz apart in a six megahertz channel.

15. The method of claim 6, wherein the portable hand held diagnostic tool is battery powered.

16. A method of receiving CATV services to supplier equipment in a drop system in a CATV system, comprising:
a CATV subscriber contracting for a first service from a service provider, the first service to be provided to at least one first supplier equipment in a CATV subscriber drop system in a CATV system between the service provider and CATV subscriber device;
receiving a portable handheld digital service diagnostic tool and the first supplier equipment for viewing the first service at the CATV subscriber device;
determining a first subset of user-side ports in the CATV subscriber drop system that are outputting a fiber optic digital service marker using the portable handheld digital service diagnostic tool, where each of the first subset of user-side ports illuminate an indicator of the portable handheld digital service diagnostic tool when the portable handheld digital service diagnostic tool is temporarily connected to terminate each of the first subset of user-side ports in the CATV subscriber drop system, the determining performed by the CATV subscriber; and
installing the first supplier equipment in the CATV subscriber drop system by first connecting the first supplier equipment to a user device and second connecting the first supplier equipment to one of the first subset of user-side ports, the installing performed by the CATV subscriber.

17. The method of claim 16, comprising:
providing the first service using a downstream bandwidth transmitted by the service provider to the CATV subscriber drop system;
transmitting the fiber optic digital service marker in the downstream bandwidth including the first service, the downstream bandwidth provided to the CATV subscriber drop system; and
displaying the first service at the user device, wherein said receiving comprises purchasing the first supplier equipment at a retail outlet or remotely from a representative of the service provider.

18. The method of claim 16, comprising shipping the portable handheld digital service diagnostic tool to the service provider or discarding the portable handheld digital service diagnostic tool.
